(19) United States
(12) Patent Application Publication
(10) Pub. No.: US 2004/0083224 A1
(43) Pub. Date: Apr. 29, 2004

(54) Document automatic classification system, unnecessary word determination method and document automatic classification method

(75) Inventor: Issei Yoshida, Yokohama Shi (JP)

Correspondence Address: INTERNATIONAL BUSINESS MACHINES CORP, IP LAW, 555 BAILEY AVENUE , J46/G4, SAN JOSE, CA, 95141, US

(73) Assignee: International Business Machines Corporation, Armonk, NY (US)

(21) Appl. No.: 10/688,217

(22) Filed: Oct. 15, 2003

(30) Foreign Application Priority Data
Oct. 16, 2002 (JP) 2002-301539

(51) Int. Cl. G06F 17/00

(52) U.S. Cl. 707/100

(57) ABSTRACT

It is an object of the present invention to eliminate unnecessary words effectively in document automatic classification.

A document automatic classification system comprising a classified document set storage device 21 for storing documents classified according to category, a category table generation unit 31 for generating a table broken down by category including information on a frequency of appearance of a word contained in a document acquired from the classified document set storage device 21, an unnecessary word determination and elimination unit 32 for eliminating an unnecessary word for each category from the table on the basis of a frequency of appearance in each category of a given word acquired from the table broken down by category generated by the category table generation unit 31, a classification catalog storage device 22 for storing the table from which the unnecessary word was eliminated by the unnecessary word determination and elimination unit 32, a classification target document storage device 23 for storing documents to be classified, and a document classification processing unit 33 for classifying the documents to be classified stored in the classification target document storage device 23 by using the table stored in the classification catalog storage device 22.

### FIELD OF THE INVENTION

The present invention relates to a document automatic classification system for classifying document data automatically, and more particularly to a document automatic classification system for eliminating unnecessary words effectively.

### BACKGROUND OF THE INVENTION

In recent years, along with mass-distribution of digitized document data (text), a document automatic classification system is attracting attention; the system automatically classifies large volumes of documents existing in a document storage database, for example. The document automatic classification system comprises two elements, namely, a learning function and a classificatory function. To provide these functions, decision tree, neural network, vector space model, and other various models are suggested. In any method, it is important to extract words identifying respective categories or documents from documents. When words are picked out in the order of frequency, however, useless words (unnecessary words) top the list. By eliminating the unnecessary words before learning and classification, the classification performance of the document automatic classification system can be remarkably improved.

There are generally two types of unnecessary words; function words and general words. The function words include a particle, an auxiliary, and the like representing a relation between two words. Many of the function words do not exist in any category and therefore they can be eliminated by checking parts of speech of the words or by generating an unnecessary word list previously. On the other hand, the general words represent generally used words other than the function words. The general words are often determined according to frequency of appearance of the words unlike the function words, generally by using a method in which they are determined to be unnecessary words if the frequency of appearance in a given document set exceeds an upper or lower limit. As a method of determining the upper or lower limit, there is already known a Zipf's law in which too many or few words are determined and eliminated on the basis of an empirical rule related to the frequency of appearance of the words.

There is a conventional art related to a document automatic classification technology, which provides a more detailed analysis of a degree of association with categories of documents to be classified by learning plural category words from classified documents and detailing a degree-of-association table or frequency information on words in the documents to be classified with focusing on the plural category words, for example, thereby improving a classification precision in similar categories (See patent literature 1, for example). Additionally there is disclosed a technology which provides an unnecessary word dictionary where unnecessary words are registered, deletes a new word if new words includes the same word as an unnecessary word in the unnecessary word dictionary, and determines a word importance level of the new words from which the unnecessary word was deleted (See patent literature 2, for example). Furthermore, there is disclosed a technology for automatically generating an unnecessary word list by counting a frequency of appearance to perform a high-precision similar document retrieval and deleting a word appearing at a fixed or higher (lower) rate to improve a similarity calculation precision (See patent literature 3, for example).

Patent literature 1—Japanese Unexamined Patent Publication (Kokai) No. 10-254883 (pages 4 and 5, page 15, FIG. 1)

Patent literature 2—Japanese Unexamined Patent Publication (Kokai) No. 11-120183 (pages 3 and 4, FIG. 1)

Patent literature 3—Japanese Unexamined Patent Publication (Kokai) No. 11-259515 (pages 3 to 5, FIG. 3)

As described above, it is preferable to eliminate unnecessary words from the words to be extracted existing in the documents in order to execute a high-precision document automatic classification. In the patent literature 1, however, there is no concept of eliminating unnecessary words first and it is based on the premise that every word has at least one closely related category. Therefore, unnecessary words are registered on a list directly unless parts of speech are limited and an unnecessary word list is not generated, by which it gets hard to perform the high-precision classification. In addition, a detailed degree-of-association table is generated anew after generating a relation table, which requires a large storage capacity.

While unnecessary words are eliminated by a comparison with a prepared unnecessary word list in the patent literature 2, the unnecessary word list need be regenerated for each set of target categories and therefore the technology is insufficient to deal with terms changing with the times. Furthermore, although a frequency of appearance of each word is counted in the entire learning document in the patent literature 3, the method does not get beyond setting a reference value of the frequency and eliminating words exceeding it, and therefore it is likely to result in a lot of remaining unnecessary words; on the other hand if unnecessary words are widely determined, it causes a problem that useful words for classification are also eliminated. Furthermore, in the above Zipf's law, words not exceeding the upper or lower limit may include unnecessary words or words exceeding the upper or lower limit may include important words identifying a category to the contrary in some cases.

### SUMMARY OF THE INVENTION

The present invention has been provided to resolve the above-mentioned technical problems. It is an object of the present invention to eliminate unnecessary words effectively in a document automatic classification.

To accomplish the object, according to a first aspect of the present invention, there is provided a document automatic classification system for automatically classifying documents into categories, comprising: list generation means for generating a word list for each category by extracting words from a learning document set, unnecessary word determination means for relatively determining an unnecessary word for each category on the basis of a frequency of appearance of a given word in each category by using the list generated by the list generation means, classification catalog storage means for storing a list for each category from which unnecessary words were eliminated based on the determination with the unnecessary word determination means, and document classification means for performing classification processing for classification target documents by using the classification catalog stored in the classification catalog storage means.

In the above, the list generation means generates a list indicating a frequency of appearance of a given word for each category from the learning document set in the storage means. If the unnecessary determination means extracts a word belonging to a given category and determines it to be an unnecessary word if the word appears more frequently than a given standard in another category, the unnecessary word can be determined on the basis of a relative frequency of appearance between categories, thereby achieving an effective elimination of the unnecessary word. Furthermore, the unnecessary word determination means determines the word extracted from the given category to be an unnecessary word if it appears more frequently in another category than a given standard determined according to a predetermined threshold and the number of documents belonging to another category.

According to another aspect of the present invention, there is provided a document automatic classification system, comprising: a classified document set storage device for storing documents classified according to category, a category table generation unit for generating a table broken down by category including information on a frequency of appearance of a word contained in a document acquired from the classified document set storage device, an unnecessary word elimination unit for eliminating an unnecessary word for each category from the table on the basis of a frequency of appearance in each category of a given word acquired from the table broken down by category generated by the category table generation unit, a classification catalog storage device for storing the table from which the unnecessary word was eliminated by the unnecessary word elimination unit, a classification target document storage device for storing classification target documents to be classified, and a document classification processing unit for performing classification processing for the classification target documents stored in the classification target document storage device by using the table stored in the classification catalog storage device.

On the other hand, the present invention provides in still another aspect an unnecessary word determination method in a document automatic classification system, comprising the steps of: extracting a word contained in a document for each category from a storage device storing a learning document set by using category table generation means and generating a list containing information on a frequency of appearance of the extracted word for each category, recognizing a frequency of appearance in other categories of a given word belonging to a given category by using the generated list by using unnecessary word determination means; and determining an unnecessary word for each category on the basis of the recognized frequency of appearance.

In this method, if the step of determining the unnecessary word is characterized by that the unnecessary word is determined according to whether one word selected from the given category appears in other categories more frequently than a given standard, it is preferable in that a word useless against identifying a category can be eliminated effectively. Furthermore, the given standard may be a value obtained from the number of documents in other categories and a predetermined given threshold. According to another aspect of the invention, the given standard can be determined according to a word frequency in other categories and a total frequency of all words in other categories.

According to still another aspect of the invention, there is provided a document automatic classification method, comprising the steps of: acquiring information on words for each category from a document set classified according to category stored in a storage device, recognizing a frequency of appearance in other categories of a word belonging to a given category on the basis of the acquired information, determining whether the word is unnecessary for identifying the given category on the basis of the recognized frequency, generating a document classification catalog by eliminating words determined to be unnecessary, storing the generated classification catalog into the storage device, and performing classification processing for classification target documents by using the classification catalog stored in the storage device.

The present invention is also applicable to a program enabling a computer to perform functions. More specifically, the invention may be understood as a program for enabling a computer to provide the functions of: extracting a word contained in a document for each category from a storage device storing a learning document set, generating a list including information on a frequency of appearance of the extracted word for each category, recognizing a frequency of appearance in other categories of a given word belonging to a given category by using the generated list, determining an unnecessary word for each category on the basis of the recognized frequency of appearance, and generating a classification list by using the determined unnecessary word.

Furthermore, the present invention may be understood as a program for enabling a computer to provide the functions of: acquiring information on words for each category from a document set classified according to category stored in a storage device, recognizing a frequency of appearance in other categories of a word belonging to a given category on the basis of the acquired information, determining whether the word is unnecessary for identifying the given category on the basis of the recognized frequency, generating a document classification catalog by eliminating the word determined to be unnecessary, and classifying the documents to be classified by using the generated classification catalog.

These programs can be provided in a form of programs installed in a computer when the computer is supplied to a customer or in a form of programs computer-readably stored in a storage medium so that the computer executes the programs. The storage medium is a CD-ROM, for example. A CD-ROM reader or the like reads programs and a flash ROM or the like stores these programs for execution. Furthermore, these programs may be provided via a network using a program transmission device, for example. The program transmission device is arranged in a server on the network, for example, and comprises a memory storing the programs and program transmission means for providing the programs via the network.

### BRIEF DESCRIPTION OF THE DRAWINGS

The preferred embodiments of the present invention will hereinafter be described in detail with reference to the accompanying drawings in which like reference numbers represent corresponding elements throughout:

FIG. 1 is a block diagram showing a configuration of a document automatic classification system according to the embodiment;

FIG. 2 is a flowchart of processing performed by a category table generation unit;

FIG. 3 is a diagram showing an example of a table generated by the category table generation unit as described by referring to FIG. 2 and stored in a memory;

FIG. 4 is a flowchart of processing performed by an unnecessary word elimination unit;

FIGS. 5A to 5C are diagrams of assistance in explaining the unnecessary processing algorithm in more detail;

FIG. 6 is a diagram of assistance in explaining a condition after eliminating unnecessary words from all categories through processing in FIGS. 5A to 5C;

FIG. 7 is a diagram showing an example of a category table after eliminating unnecessary words from the example of the table generated by the category table generation unit and stored in the memory shown in FIG. 3;

FIGS. 8A and 8B are diagrams of assistance in explaining a vector space model used in the embodiment; and

FIG. 9 is a flowchart of document classification processing executed by the document classification processing unit by using the vector space model.

### PREFERRED EMBODIMENT OF THE INVENTION

In the following description of the preferred embodiment, reference is made to the accompanying drawings which form a part thereof, and which is shown by way of illustration a specific embodiment in which the present invention may be practiced. It is to be understood that other embodiments may be utilized as structural changes may be made without departing from the scope of the present invention.

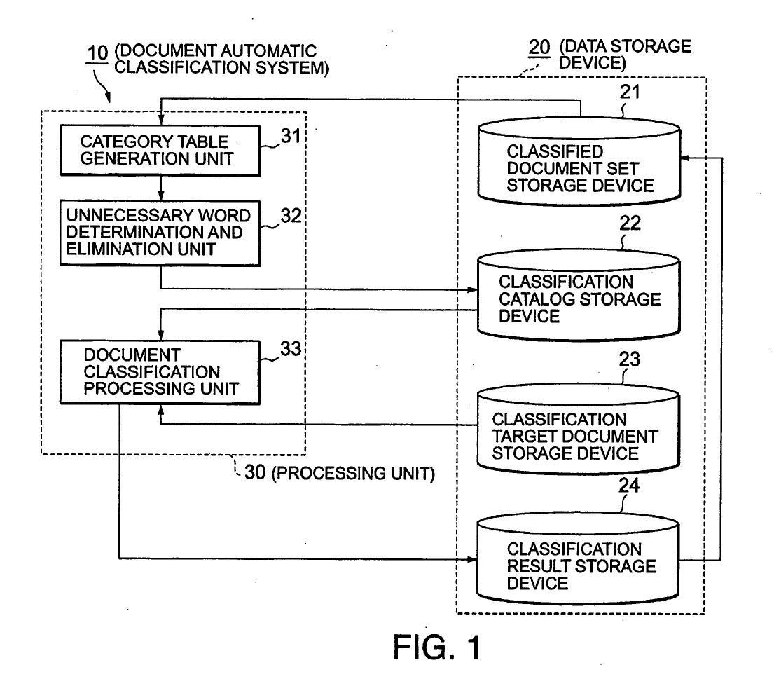

Referring to FIG. 1, there is shown a block diagram of a configuration of a document automatic classification system 10 according to this embodiment. The document automatic classification system 10 comprises a data storage device 20 storing various data expanded by a computer such as a personal computer (PC) and composed by an external memory such as a hard disk drive (HDD) and a processing unit 30 run by a CPU using an application program read from the external memory. Practically block components of the processing unit 30 are expanded by an internal memory comprising a plurality of DRAM chips used as an area for reading a CPU execution program or a work area for writing execution program processing data.

The data storage device 20 comprises a classified learning document set storage device 21 for storing a learning document set, namely, classified documents for use in learning categories, a classification catalog storage device 22 for storing a classification catalog after eliminating unnecessary words, a classification target document storage device 23 for storing text to be subject to document classification processing practically, and a classification result storage device 24 for storing a result of the classification. The content of the classification result storage device 24 can also be stored in the classified document set storage device 21 and be composed in such a way that it can be used for learning processing. The term “unnecessary word” here is defined as a word useless against identifying a category, for example.

The processing unit 30 comprises a category table generation unit 31 for generating table information as a word list for each category selected before eliminating unnecessary words, an unnecessary word determination and elimination unit 32 for executing processing of determining unnecessary words and of eliminating the determined unnecessary words about words on the category table generated by the category table generation unit 31, and a document classification processing unit 33 for executing the document classification processing practically.

The category table generation unit 31 generates a table including information such as frequencies of appearance of words, for example, by using documents obtained from the classified document set storage device 21 and registers it as table information into the internal memory. The classified document set storage device 21 stores a plurality of documents, which are learning documents, with the documents classified into category sets such as, for example, “politics,” “economics,” and “sports.” The category table generation unit 31 reads the documents classified into the category sets, analyzes the documents, counts frequencies of appearance of words contained in the documents, for example, and generates a category table. If the table contains a large amount of data, the data can be stored separately in the external memory, namely, the data storage device 20. In addition, it is also possible to acquire a learning document set (classified document set) via a given network instead of the classified document set storage device 21.

The unnecessary word determination and elimination unit 32 executes processing of determining unnecessary words according to a relative frequency of appearance between categories by using the category table generated by the category table generation unit 31. The category table from which unnecessary words were eliminated by the unnecessary word determination and elimination unit 32 is stored in the classification catalog storage device 22.

The document classification processing unit 33 executes document classification processing for documents to be classified which are stored in the classification target document storage device 23 by using the classification catalog (the category table from which unnecessary words were eliminated) stored in the classification catalog storage device 22. The result of classification executed by the document classification processing unit 33 is stored in the classification result storage device 24.

The following describes the category table generation processing.

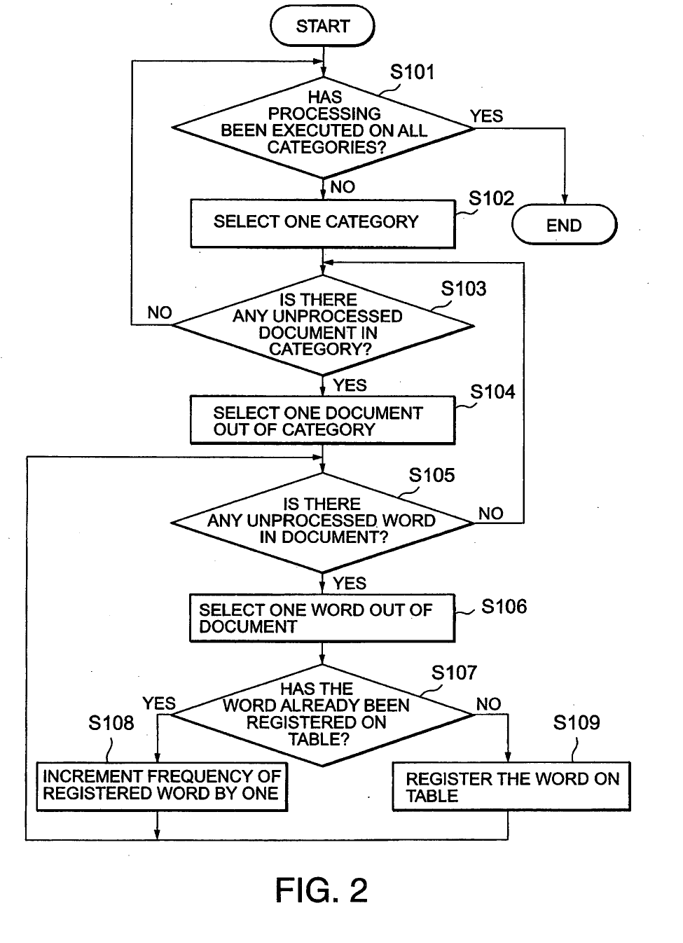

Referring to FIG. 2, there is shown a flowchart of processing executed by the category table generation unit 31. In generating the category table, the category table generation unit 31 determines whether processing has been done on all categories stored in the classified document set storage device 21 (step 101). Unless the processing has been done on all categories, it first selects one category (step 102) and determines whether unprocessed documents exist in the category (step 103). If there is no such document in the category, the control returns to the step 101; otherwise, one document is selected out of the category (step 104). Then, it is determined whether an unprocessed word exists in the document (step 105). If no unprocessed word remains, the control returns to the step 103; if any unprocessed word remains in the document yet, one word is selected out of the document (step 106). A morphological analysis is used for the word extraction. In addition, filtering with a part of speech can be performed at this timing.

It is then determined whether the word has already been registered on the table (category table) (step 107); if it is registered, a frequency (a frequency of appearance) of the registered word on the table is incremented by one and the control returns to the step 105. Unless it is registered, the word is registered on the table (step 109) and the control returns to the step 105. The table (category table) may have information on each word as well as the words and their frequencies of appearance. For example, it can contain part-of-speech information; if so, the part-of-speech information is also registered on the table. After a series of the processes, the category table generation processing terminates if it is determined that the processing has been done on all categories in the step 101.

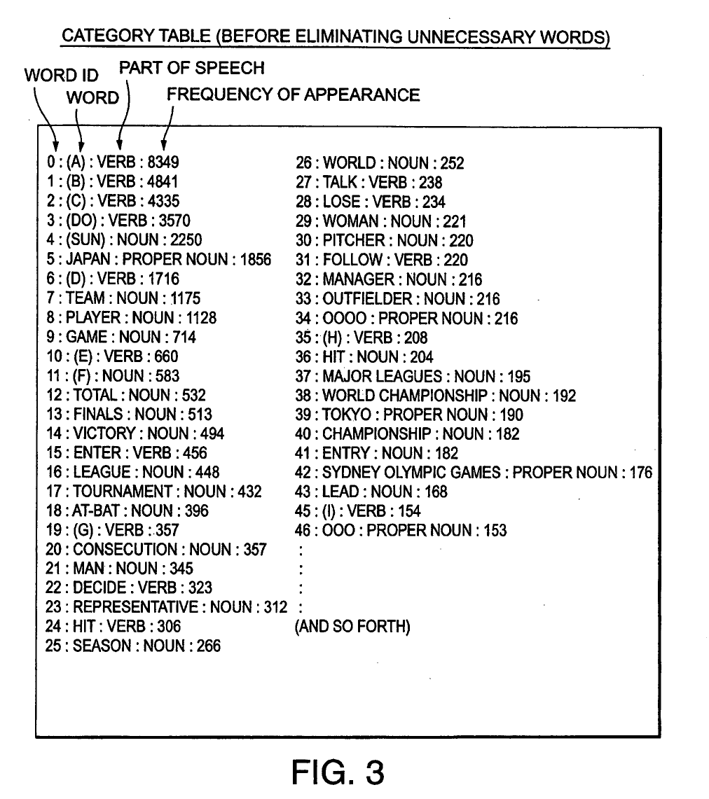

Referring to FIG. 3, there is shown a diagram of a sample table generated by the category table generation unit 31 as described in FIG. 2 and stored in the memory. This diagram shows a sample table before eliminating unnecessary words in the “sports” category. The table information shows a word, a part of speech of the word, and a frequency of appearance of the word for each word ID, which is a number for use in identifying the word. The frequency of appearance of the word indicates “the total number of times the word has appeared in a learning document set.” If the word appears twice or more in a single document, it is counted by the number of times. The example shown in FIG. 3 is a pattern diagram of a table generated by preprocessing in which only nouns and verbs are previously registered on the table.

The following describes the unnecessary word elimination processing.

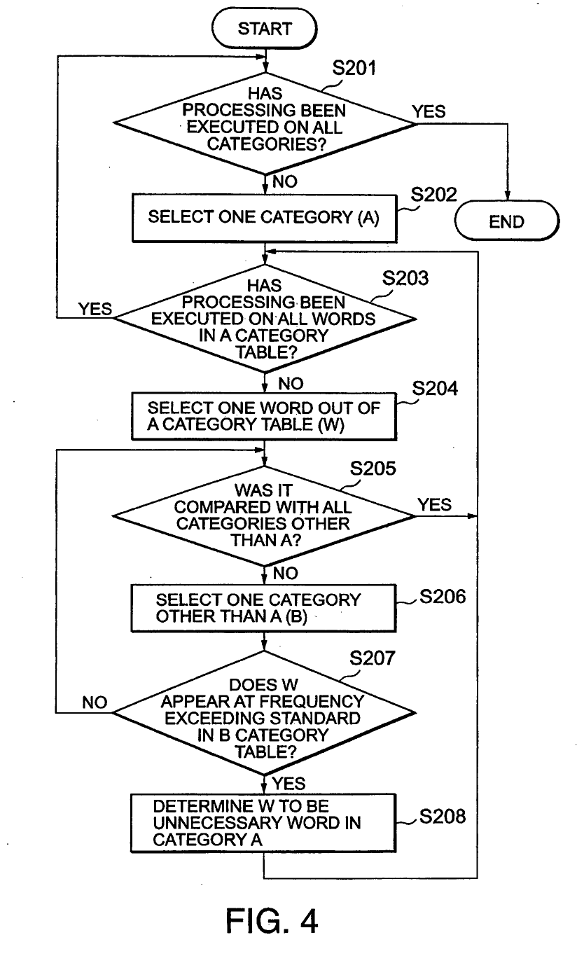

Referring to FIG. 4, there is shown a flowchart of processing performed by the unnecessary word determination and elimination unit 32. The unnecessary word determination and elimination unit 32 determines whether processing has been done on all categories by using the category table generated by the category table generation unit 31 (step 201). Unless the processing has been done on all categories, it first selects one category (assumed A) (step 202). It then determines whether processing has been done on all words in the A category table (step 203). If it has been done on all words, the control returns to the step 201; otherwise, one word (W) is selected out of the A category table (step 204). It is then determined whether a comparison with all categories other than A has been made (step 205). If the comparison has been made, the control returns to the step 203; otherwise, one category (assumed B) is selected out of the categories other than A (step 206). Thereafter, it is determined whether the B category table contains W at a frequency exceeding a predetermined standard (step 207). Unless it contains W at a frequency exceeding the standard, the control returns to the processing in the step 205; otherwise, W is determined to be an unnecessary word (step 208) and then control returns to the processing in the step 203. If it is determined that processing has been done on all categories in the step 201, the unnecessary word elimination processing terminates and table information as a result of the elimination is stored in the classification catalog storage device 22.

In other words, in the unnecessary word elimination method shown in FIG. 4, a single word W belonging to the given category A is picked out and, if it appears more frequently than the given standard in another category B, the word W is determined to be an unnecessary word in the category A. It is performed on all words belonging to the category A. Furthermore, these processes are performed for all categories other than the category A to determine unnecessary words by replacing a role of the category to be determined with another.

As a method of defining a determination in the step 207, “appears at a frequency exceeding the standard,” several methods are applicable. For example, a threshold is determined as described later. Then, if the word W appears in B at a frequency exceeding a value obtained by the following for the number of learning documents stored in the classified document set storage device 21:

the number of documents×threshold,

the condition can be defined as “appears at a frequency exceeding the standard.” As another example, if the following exceeds a certain threshold:

a frequency of word W in B÷a total frequency of all words in B,

the condition can also be defined as “appears at a frequency exceeding the standard”.

Furthermore, the unnecessary word elimination method shown in FIG. 4 can be used in a combination with another existing unnecessary word elimination method. If the category has a hierarchical structure, an application of this algorithm to a category existing in the same hierarchy enables its expansion.

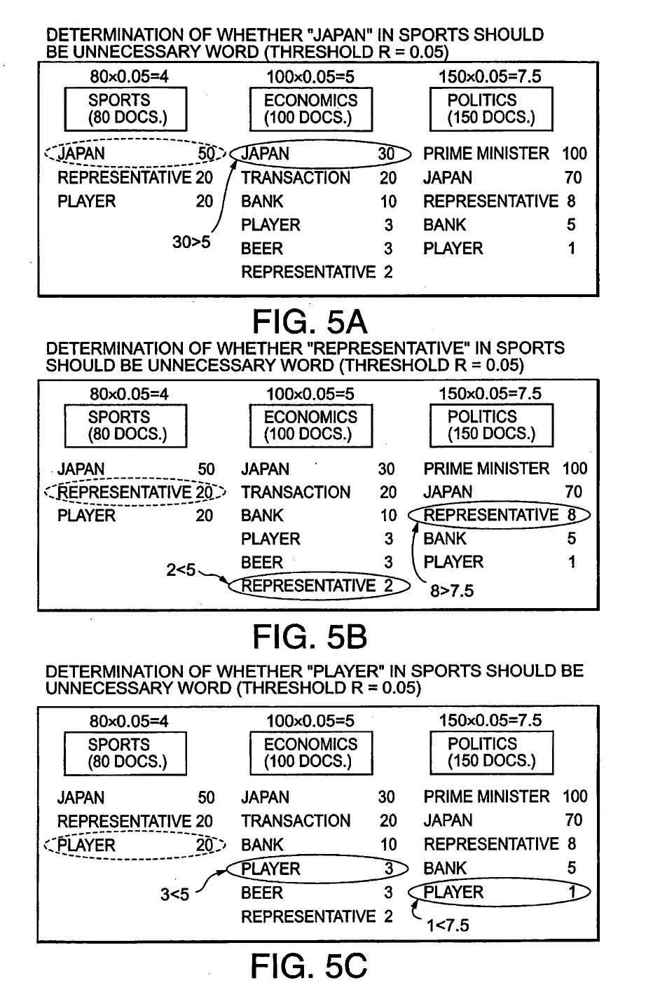

Referring to FIGS. 5A to 5C, there are shown diagrams of assistance in explaining the unnecessary word processing algorithm in more detail. In this algorithm, a threshold R (0≦R≦1) is stored in the processing unit 30, first. In the example shown in FIGS. 5A to 5C, value “0.05” is stored as the threshold. Additionally, in the example shown in FIGS. 5A to 5C, three categories, namely, sports, economics, and politics are shown and their learning document amounts are assumed 80, 100, and 150 documents, respectively. Furthermore, the word W belonging to each category shown in FIGS. 5A to 5C exists in a document belonging to each category and its numeric value indicates the frequency of the word contained in the document. At this point, it is possible to adopt an arbitrary index such as, for example, “the total number of times the word appears in the category” or “the number of documents containing the word in the category” as the frequency of the word.

As shown in FIG. 5A, it is determined whether the word “Japan” having a frequency of 50 in the category “sports” is an unnecessary word, first. While it has been conventionally determined whether the frequency 50 is simply high or low, an unnecessary word is determined on the basis of a relative frequency of appearance between categories by checking the frequency situation in other categories in this embodiment. Therefore, it is determined how often the word “Japan” is used and appears in the document in another category “economics.” More specifically, a value obtained by multiplying the number of documents in the category “economics” by the threshold R (100×0.05=5) is compared with the frequency of the word “Japan” (30). Since 30 is greater than 5 (30>5), the word “Japan” used in the category “sports” is thought to be used frequently also in another category (for example, “economics”). Therefore, in classifying documents practically, the word “Japan” is thought to be not preferable as an object of determination of the category “sports”. Therefore, the word “Japan” is determined to be an unnecessary word in the category “sports.”

Subsequently, as shown in FIG. 5B, it is determined whether the word “representative” should be an unnecessary word in the category “sports.” First, the frequency of the word “representative” is 2 in “economics” which is one of other categories and it is smaller than the value obtained by multiplying the number of documents in the category “economics” by the threshold R (100×0.05=5) (2<5). Therefore, it is not determined to be an unnecessary word in the category “sports” in this stage. The frequency of the word “representative” is 8, however, in another category “politics.” At this point, it is understood that the frequency of appearance is greater than a value obtained by multiplying the number of documents in the category “politics” by the threshold R (150×0.05=7.5) (8>7.5). As a result, the word “representative” in the category “sports” cannot be determined to be preferable as an identification word, judging from the situation of other categories. Therefore, the word “representative” in the category “sports” is determined to be an unnecessary word.

Furthermore, as shown in FIG. 5C, it is determined whether a word “player” should be an unnecessary word in the category “sports.” First, the frequency of the word “player” is 3 in the category “economics,” which is one of other categories, and it is smaller than a value obtained by multiplying the number of documents of the category “economics” by the threshold R (100×0.05=5) (3<5). Therefore, the word “player” is not determined to be an unnecessary word in the category “sports.” Furthermore, in another category “politics,” the frequency of the word “player” is 1. It is understood that the value is smaller than a value obtained by multiplying the number of documents of the category “politics” by the threshold R (150×0.05=7.5) (1<7.5). Therefore, the word “player” in the category “sports” appears less frequently in other categories and it is determined to be preferable as an identification word. The word “player” in the category “sports” is not an unnecessary word and therefore remains without being eliminated.

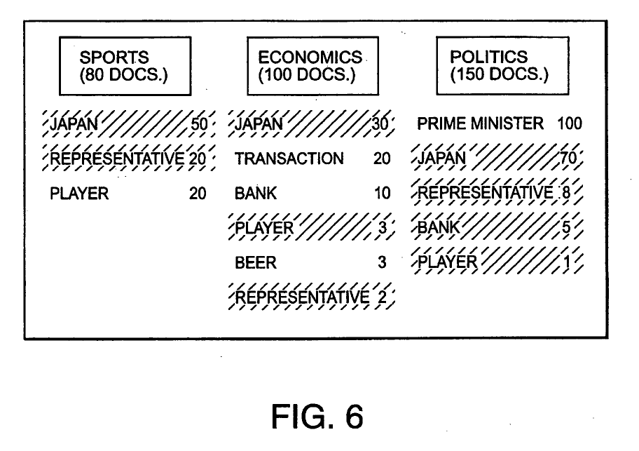

Referring to FIG. 6, there is shown a diagram of assistance in explaining a condition after unnecessary words are eliminated from all categories through the processing in FIGS. 5A to 5C. All categories are submitted to the unnecessary word elimination processing using the algorithm as set forth in the above. In FIG. 6, the words existing in the shaded areas are to be eliminated as unnecessary words. The following words are eliminated as unnecessary words, respectively: “Japan” and “representative” in the category “sports”; “Japan,” “player,” and “representative” in the category “economics”; “Japan,” “representative,” “bank,” and “player” in the category “politics.”

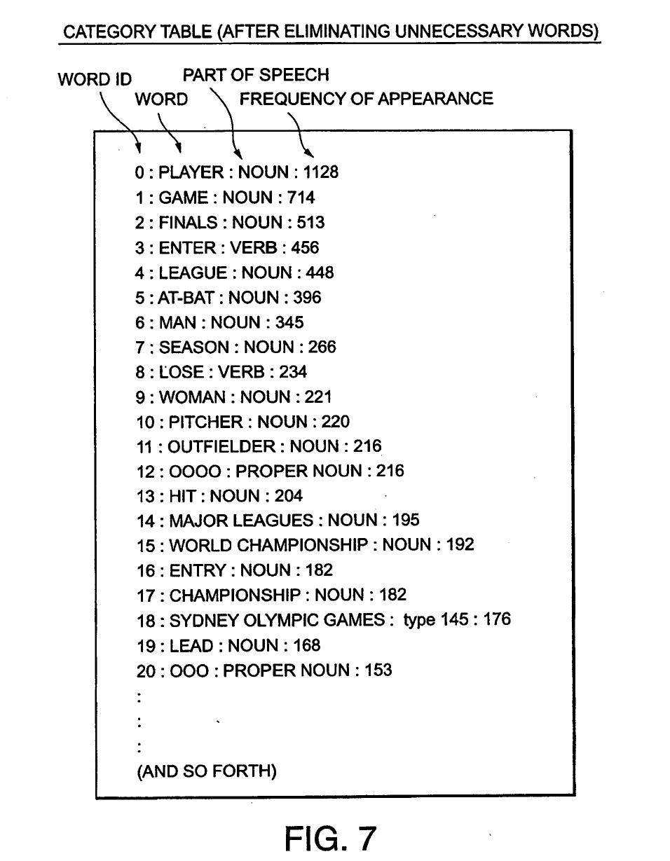

Referring to FIG. 7, there is shown a diagram showing an example of a category table after unnecessary words are eliminated from the sample table generated by the category table generation unit 31 and stored in the memory as shown in FIG. 3. In the same manner as in FIG. 3, the category “sports” is illustrated by an example. Table information shows a word, a part of speech of the word, and a frequency of appearance of the word for each word ID, which is a number for use in identifying the word remaining after eliminating the unnecessary words. In the same manner as in FIG. 3, the frequency of appearance of the word indicates “the total number of times the word has appeared in a learning document set.” The category table from which unnecessary words were eliminated by the unnecessary word determination and elimination unit 32 as shown in FIG. 7 is stored as a classification catalog in the classification catalog storage device 22. When it is stored in the classification catalog storage device 22, the word list from which unnecessary words were eliminated as shown in FIG. 7 can be stored directly or the list can be improved by applying an existing “word weighting method” to the list before it is stored.

By using the result of the unnecessary word elimination as set forth above, the document classification processing is executed practically. While there are some methods of applying the category table obtained by eliminating unnecessary words to the document classification processing, a method referred to as “vector space model” is illustrated here by an example.

The classification catalog storage device 22 stores the category table generated through the unnecessary word elimination, with pairs of a word and a word weight registered in each category. In the example shown in FIG. 6, a word “player” and a word weight “20” are registered in the category “sports.” In the case as shown in FIG. 6, for example, a vector space is assumed with a basis of a set of five words (or term), namely, “player,” “transaction,” “bank,” “beer,” and “prime minister,” and then “the distance between a document and each category” is calculated in this space. If a word appears in a plurality of categories, the word appearing repeatedly is treated as a single word in generating the vector space. In the example shown in FIG. 6, the vectors in respective categories are as follows:

Sports: (20, 0, 0, 0, 0)

Economics: (0, 20, 10, 3, 0)

Politics: (0, 0, 0, 0, 100)

The following describes a method of generating a document vector from a document to be subject to the classification. In this embodiment, a morphological analysis is made first on a document D to be subject to the classification obtained from the classification target document storage device 23 to generate a table containing words and their frequencies of appearance. For example, the morphological analysis is made on the following:

contents of document subject to classification: “The Prime Minister of country A discussed an issue of Iraq with the Prime Minister of country B.”

The following table is then generated:

(A, 1), (Country, 2), (Prime Minister, 2), (Iraq, 1), (Issue, 1), (Conference, 1)

Subsequently, the table generated as described above is compared with the basis of the vector space already generated and a vector is generated by using only information on words forming the basis of the vector space (registered), by which the vector for the classification target document is generated. In this example, the document vector generated here is as follows:

player, transaction, bank, beer, Prime Minister

(0, 0, 0, 0, 2)

Thereafter, a cosine of an angle between the vectors generated as described above is used for the calculation of “the distance between the document and each category.”

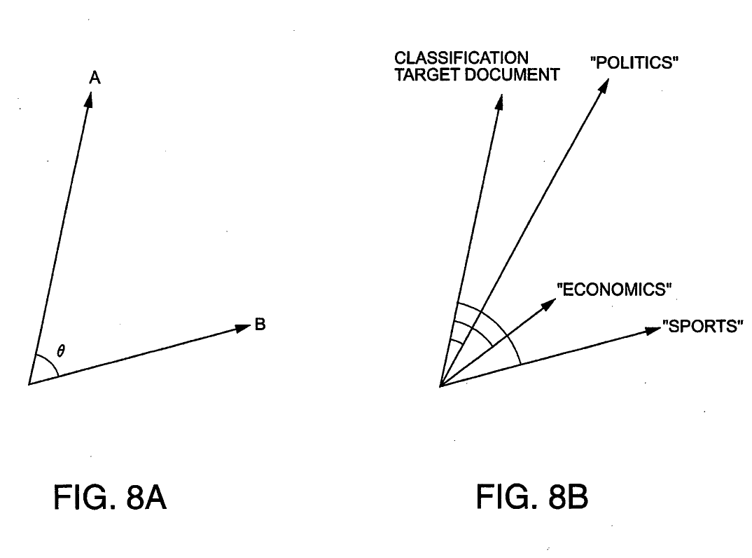

Referring to FIGS. 8A and 8B, there are shown diagrams of assistance in explaining the vector space model used in this embodiment. Assuming that θ is an angle between vector A and vector B shown in FIG. 8A, the cosine is defined as follows:

cos θ=(A·B)÷(|A∥B|)

where A·B is a product of A and B and |A| is a norm (length) of A. The cosine value, namely, cos θ is between 0 and 1 and θ gets smaller as it is closer to 1. In other words, a greater value of cos θ is thought to indicate a closer distance between A and B.

In the document classification, the cosine can be used as described below. Assuming that A is a vector corresponding to a document requiring the classification and that B is a vector corresponding to a category, the cosine between A and B is calculated for each B. The category of B making the cosine value greatest for A should be determined to be a category to which A belongs. As shown in FIG. 8B, the vector A represents the classification target document and the vector B represents each category: politics, economics, or sports. Then the cosine of the classification target document and each category of politics, economics, or sports are calculated by using the above expression. In the example shown in FIG. 8B, an angle between the classification target document and politics is the smallest and its cosine is the greatest, by which the classification target document can be determined to belong to the category “politics.”

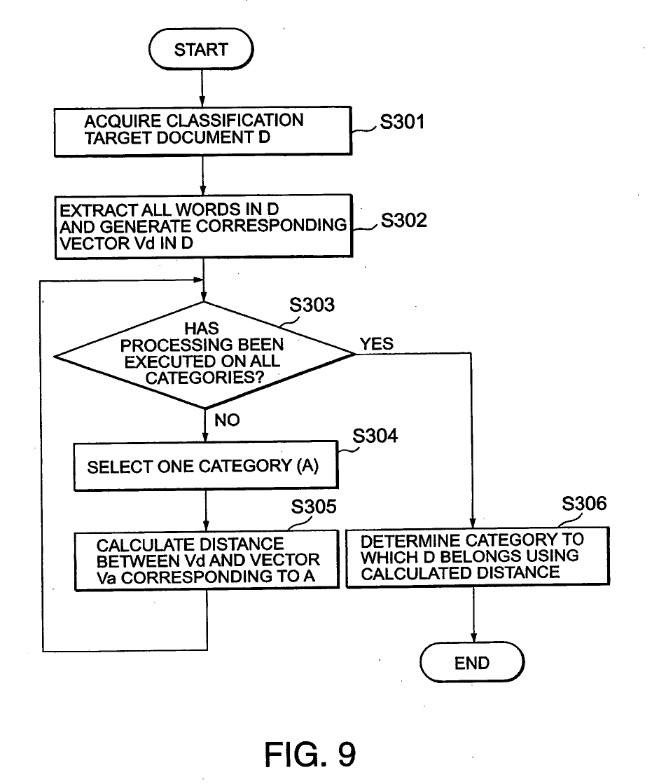

Referring to FIG. 9, there is shown a flowchart of the document classification processing executed by the document classification processing unit 33 using the vector space model. The document classification processing unit 33 acquires the classification target document D from the classification target document storage device 23, first (step 301). Subsequently, it extracts all words of the classification target document D and generates a vector Vd corresponding to the classification target document D (step 302). At this point, it is determined whether the processing has been done on all categories (step 303); if not, one category is selected and it is assumed A (step 304). Then the distance between the vector Vd and the vector Va corresponding to A is calculated as described above (step 305). If the control returns to the step 303 and the processing has been done on all categories, the calculated distance is used to determine the category to which the classification target document D belongs (step 306) and the result is stored in the classification result storage device 24, by which the processing terminates.

As set forth in detail hereinabove, in this embodiment, unnecessary words are eliminated based on a relative frequency of appearance between categories by using a definition of “a word appears more frequently than a certain level in one of other categories” in the document automatic classification. This enables a new definition of useless words (unnecessary words) in identifying a category and the definition enables more effective elimination of the unnecessary words than in the conventional methods. Furthermore, a list from which unnecessary words were eliminated is stored in the classification catalog storage device 22 and actual document classification processing is executed by using the list, thereby bypassing the need to determine whether the words are unnecessary in the actual document processing. In other words, there is no need for analyzing the actual classification target document and eliminating unnecessary words, thereby enabling a rapid classification work.

### ADVANTAGES OF THE INVENTION

As set forth hereinabove, according to the present invention, it becomes possible to eliminate unnecessary words effectively in the document automatic classification.

What is claimed is:

1. A document automatic classification system, comprising:
list generation means for generating a word list for each category by extracting words from a learning document set; and
unnecessary word determination means for relatively determining an unnecessary word for each category on the basis of a frequency of appearance of a given word in each category by using the list generated by said list generation means.

2. The system according to claim 1, wherein said list generation means generates a list indicating a frequency of appearance of a given word for each category from said learning document set in the storage means.

3. The system according to claim 1, wherein said unnecessary word determination means extracts a word belonging to a given category and determines it to be an unnecessary word if the word appears more frequently than a given standard in another category.

4. The system according to claim 1, wherein said unnecessary word determination means determines the word extracted from said given category to be an unnecessary word if it appears more frequently in another category than the given standard determined according to a predetermined threshold and the number of documents belonging to said another category.

5. The system according to claim 1, further comprising:
classification catalog storage means for storing a list for each category from which unnecessary words were eliminated based on the determination with said unnecessary word determination means; and
document classification means for performing classification processing for classification target documents by using said classification catalog stored in the classification catalog storage means.

6. A document automatic classification system, comprising:
a classified document set storage device for storing documents classified according to category;
a category table generation unit for generating a table broken down by category including information on a frequency of appearance of a word contained in a document acquired from said classified document set storage device;
an unnecessary word elimination unit for eliminating an unnecessary word for each category concerned from the table on the basis of a frequency of appearance in each category of a given word acquired from the table broken down by category generated by said category table generation unit; and
a classification catalog storage device for storing the table from which the unnecessary word was eliminated by said unnecessary word elimination unit.

7. The system according to claim 6, further comprising:
a classification target document storage device for storing classification target documents to be classified; and
a document classification processing unit for performing classification processing for the classification target documents stored in said classification target document storage device by using said table stored in said classification catalog storage device.

8. The system according to claim 6, wherein said unnecessary word elimination unit extracts a word belonging to a given category and eliminates the word as an unnecessary word from said table if the word appears more frequently than a given standard in another category.

9. The system according to claim 6, wherein said table broken down by category generated by said category table generation unit contains information on the word, a frequency of appearance of the word, and a part of speech of the word.

10. An unnecessary word determination method in a document automatic classification system, comprising the steps of:
extracting a word contained in a document for each category from a storage device storing a learning document set;
generating a list containing information on a frequency of appearance of the extracted word for each category;
recognizing a frequency of appearance in other categories of a given word belonging to a given category by using the generated list; and
determining an unnecessary word for each category on the basis of the recognized frequency of appearance.

11. The method according to claim 10, wherein, in said step of determining the unnecessary word, the unnecessary word is determined according to whether one word selected from the given category appears in said other categories more frequently than a given standard.

12. The method according to claim 11, wherein said given standard is a value obtained from the number of documents in said other categories and a predetermined given threshold.

13. The method according to claim 11, wherein said given standard is determined according to said frequency of the word in said other categories and a total frequency of all words in said other categories.

14. An unnecessary word determination method in a document automatic classification system, comprising the steps of:
acquiring information on words for each category from a document set classified according to category stored in a storage device;
recognizing a frequency of appearance in other categories of a word belonging to a given category on the basis of the acquired information; and
determining whether the word is unnecessary for identifying the given category on the basis of the recognized frequency.

15. The method according to claim 14, further comprising the steps of:
generating a document classification catalog by eliminating words determined to be an unnecessary word; and
storing said classification catalog into the storage device.

16. The method according to claim 1, further comprising the step of performing classification processing for classification target documents by using the classification catalog stored in said storage device.
